(19) United States
(12) Patent Application Publication
(10) Pub. No.: US 2002/0116671 A1
(43) Pub. Date: Aug. 22, 2002

(54) Alarm display unit of IC tester

(76) Inventor: Hiroto Uchiyama, Tokyo (JP)

Correspondence Address: SAMUEL BORODACH, Fish & Richardson P.C., Suite 2800, 45 Rockefeller Plaza, New York, NY, 10111, US

(21) Appl. No.: 10/047,524

(22) Filed: Oct. 23, 2001

(30) Foreign Application Priority Data
Oct. 23, 2000 (JP) P2000-322208

(51) Int. Cl. G06F 11/00

(52) U.S. Cl. 714/57

(57) ABSTRACT

An alarm display unit of an IC tester for displaying an alarm when there is an abnormality in a measured IC, constituted by: a sampling control portion 2D for collecting data beforehand so as to decide a permissible value for issuing an alarm display; a permissible value calculation portion 2E for calculating the permissible value for issuing the alarm display on the basis of the data collected by the sampling control portion 2D; and an alarm control portion 2F for judging whether the alarm is to be displayed or not, on the basis of the permissible value calculated by the permissible value calculation portion 2E and a measured value obtained from the measured IC.

### BACKGROUND OF THE INVENTION

1. Field of the Invention

The present invention relates to an alarm display unit of an IC (integrated circuit) tester, and particularly having a function to establish alarm conditions while testing an IC, and to display an alarm on the basis of the established alarm conditions.

2. Description of the Related Art

When decisions of failures are made continuously, there is a possibility that an abnormality occurs in a measured IC or an IC tester. Therefore, a conventional IC tester displays an alarm to clear up causes of the abnormality. As for the alarm conditions for displaying the alarm, a permissible value for the number of continuous failures is set in advance. The number of times of decisions of failures made continuously, that is, the number of continuous failures is measured in an IC test. Then, it is judged whether the number of continuous failures has exceeded the permissible value or not. If the number of continuous failures has exceeded the permissible value, an alarm is displayed.

The alarm condition, that is, the permissible value for an alarm display unit of the conventional IC tester is an empirical value based on past failure rates and so on. Therefore, there is a fear that a permissible value is set in no consideration of scattering in product quality or the like different in accordance with every kind of IC to be measured. For example, there is a fear that a permissible value is set to be too large. If a test is carried out in the state in which a permissible value set to be too large and the test is kept on being carried out in this state, that is, in the abnormal state, a retest or the like is required to be carried out retroactively to the point of time when the test had been carried out in a normal state. Thus, enormous time will be wasted.

### SUMMARY OF THE INVENTION

The present invention has been made to solve the foregoing problem. An object of the present invention is to provide an alarm display unit of an IC tester in which a permissible value can be set in accordance with the kind of IC to be measured.

According to an aspect of the present invention, there is provided an alarm display unit of an IC tester for displaying an alarm when there is an abnormality in a measured IC, the alarm display unit being constituted by: a sampling control portion for collecting data beforehand so as to decide a permissible value for issuing an alarm display; a permissible value calculation portion for calculating the permissible value for issuing the alarm display on the basis of the data collected by the sampling control portion; and an alarm control portion for judging whether the alarm is to be displayed or not, on the basis of the permissible value calculated by the permissible value calculation portion and a measured value obtained from the measured IC.

According to another aspect of the present invention, the alarm display unit further comprises: a sampling memory for storing the data collected beforehand by the sampling control portion; a permissible value memory for storing the permissible value calculated by the permissible value calculation portion; and a measured value memory for storing the measured value obtained from the measured IC, the measured value being used for comparison performed by the alarm control portion.

According to a further aspect of the present invention, the sampling control portion collects beforehand data of numbers of continuous failures in which the measured IC fails continuously; the permissible value calculation portion calculates a mean value u and a standard deviation a of the data of numbers of continuous failures collected by the sampling control portion, and sets a value of μ+3σ as the permissible value; and the alarm control portion compares the value of μ+3σ calculated by the permissible value calculation portion with the measured value of number of continuous failures obtained from the measured IC, and judges whether the alarm is to be displayed or not, on the basis of a result of the comparison.

According to a still further aspect of the present invention, the alarm display unit further comprises: a sampling memory for storing the data of numbers of continuous failures collected by the sampling control portion beforehand; a permissible value memory for storing the value of μ+3σ calculated by the permissible value calculation portion; and a measured value memory for storing the measured value of number of continuous failures obtained from the measured IC, the measured value of number of continuous failures being used for comparison performed by the alarm control portion.

### BRIEF DESCRIPTION OF DRAWINGS

FIG. 1 is a block diagram of an alarm display unit of an IC tester according to an embodiment of the present invention.

FIG. 2 is a flow chart for explaining the operation of the embodiment of the present invention.

FIG. 3 is a flow chart for explaining the sampling operation in a sampling control portion 2D.

FIG. 4 is a diagram showing the configuration of a sampling memory 2C1.

FIG. 5 is a flow chart showing a process for calculating a permissible value in a permissible value calculation portion 2E.

FIG. 6 is a flow chart showing a process of an IC test in an alarm control portion 2F.

FIG. 7 is a diagram showing an example of the sampling result.

### EMBODIMENT OF THE INVENTION

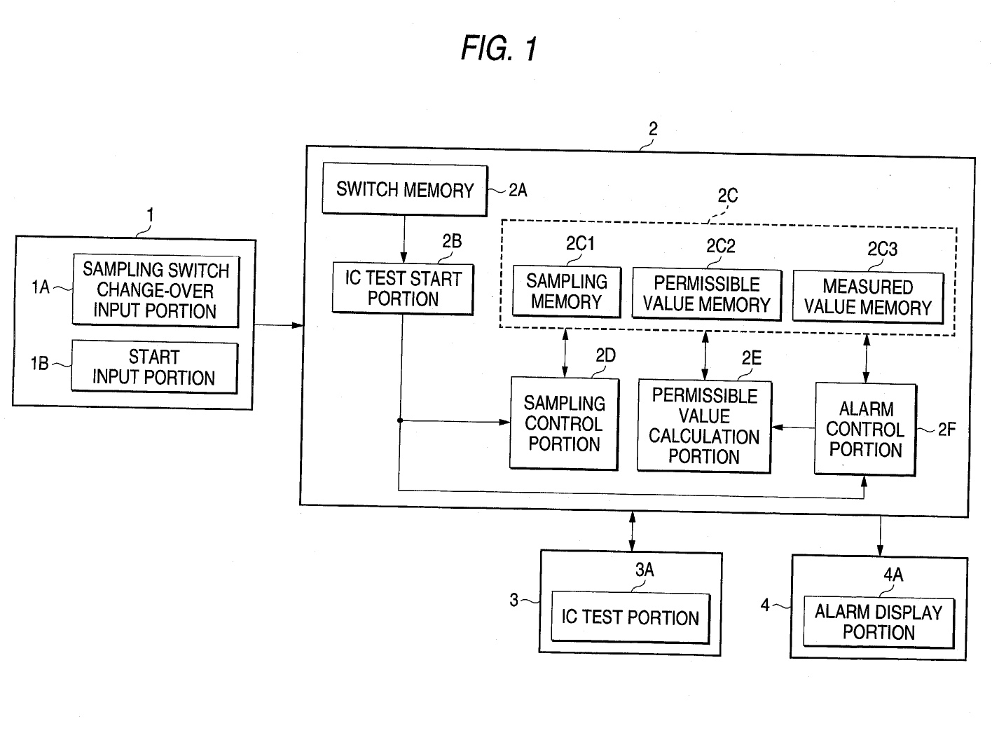

FIG. 1 is a block diagram of an alarm display unit of an IC tester according to an embodiment of the present invention. The configuration of this embodiment will be described with reference to FIG. 1. An input unit 1 such as a keyboard or the like, an IC tester 3 for testing an IC, and a display unit 4 are connected to an IC test control unit 2 for controlling the IC tester 3.

The input unit 1 has a sampling switch changer-over input portion 1A for inputting whether sampling is to be carried out or not, and a start input portion 1B. The IC test control unit 2 has a switch memory 2A for storing whether sampling is carried out or not, an IC test start portion 2B, a memory portion 2C, a sampling control portion 2D, a permissible value calculation portion 2E, and an alarm control portion 2F. The memory portion 2C has a sampling memory 2C1, a permissible value memory 2C2, and a measured value memory 2C3. The sampling memory 2C1 stores a sampling result, that is, a measuring result of the number of continuous failures measured by sampling. The permissible value memory 2C2 stores a permissible value. The measured value memory 2C3 stores a value (count value) of the number of continuous failures which is being measured. The IC tester 3 has an IC test portion 3A. The display unit 4 has an alarm display portion 4A.

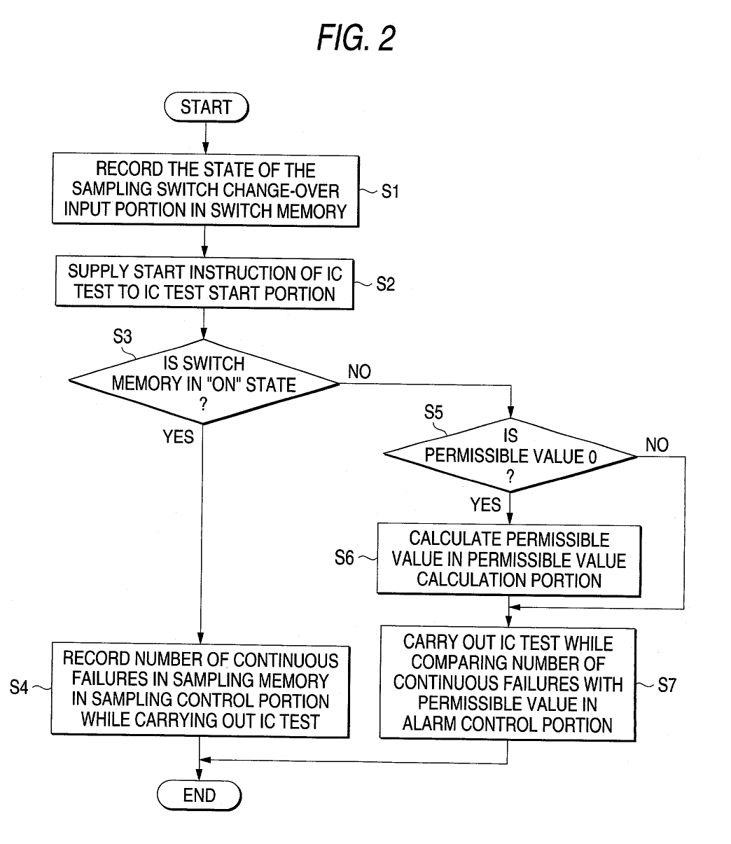

FIG. 2 is a flow chart for explaining the operation of the embodiment. The operation of the embodiment will be described with reference to the flow chart of FIG. 2. First, an operator inputs, from the sampling switch change-over input portion 1A, whether data is to be collected (sampled) for setting alarm conditions. Then, in Step S1, the state of the sampling switch change-over input portion 1A is stored in the switch memory 2A. When sampling is performed (when an IC is tested while sampling is carried out), “ON” state of the sampling switch change-over input portion 1A is stored in the switch memory 2A.

In Step S2, the start input portion 1B supplies, to the IC test start portion 2B, a start instruction to start an IC test. Then, in Step S3, the IC test start portion 2B detects whether the state of the switch memory 2A is “ON” or not. If the state of the switch memory 2A is “ON” (Yes), in Step S4, the IC test start portion 2B outputs a start instruction to the sampling control portion 2D so that the sampling control portion 2D collects (samples) data and makes the sampling memory 2C1 store the collected data.

If the state of the switch memory 2A is not “ON” (No) in Step S3, detection is made in Step S5 as to whether a permissible value has been stored in the permissible value memory 2C2 or not, that is, whether the value stored in the permissible value memory 2C2 is 0 or not. If the value stored in the permissible value memory 2C2 is 0 (Yes), conclusion is made that no permissible value has been stored, and in Step S6, the permissible value calculation portion 2E calculates a permissible value and makes the permissible value memory 2C2 store the calculated permissible value. Then, in Step 7, an IC is tested while the alarm control portion 2F compares the number of continuous failures measured with the permissible value stored in the permissible value memory 2C2.

If the value stored in the permissible value memory 2C2 is not 0 (No) in Step S5, conclusion is made that a permissible value has been stored, and in Step S7, an IC is tested while the alarm control portion 2F compares the number of continuous failures measured with the permissible value stored in the permissible value memory 2C2.

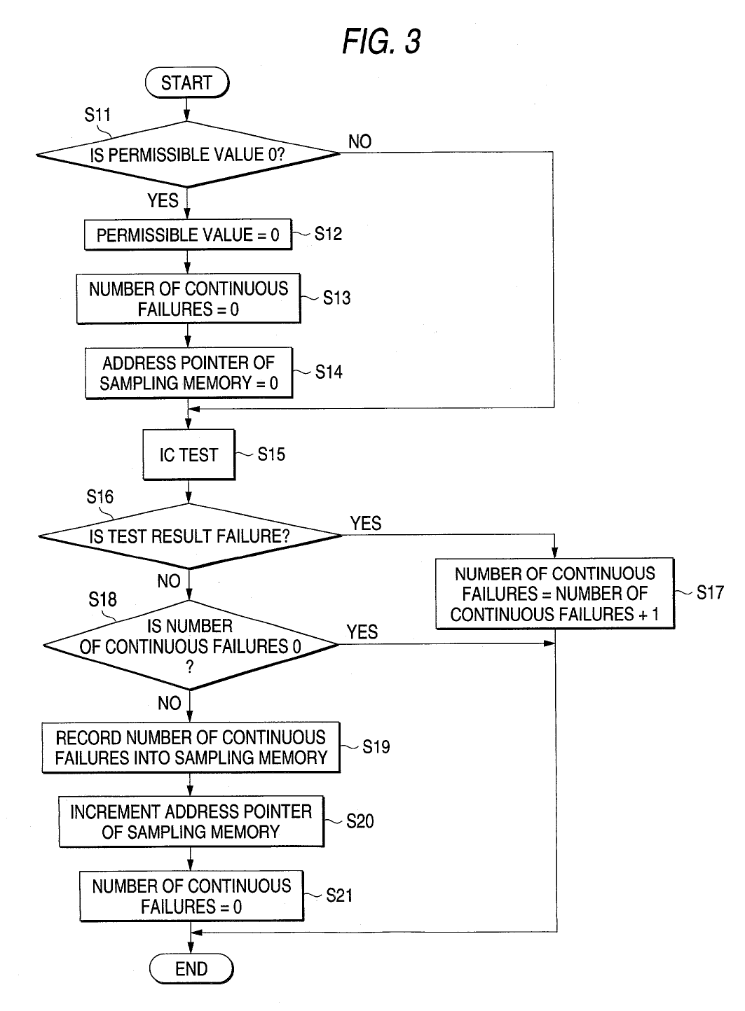

FIG. 3 is a flow chart for explaining the sampling operation in the sampling control portion 2D. The sampling operation in the sampling control portion 2D will be described with reference to the flow chart of FIG. 3. In Step S11, judgment is made as to whether initialization has been carried out or not on the basis of the value stored in the permissible value memory 2C2. If the value stored in the permissible value memory 2C2 is 0 (No), conclusion is made that initialization has been carried out, the operation goes to Step S15 which will be described later. If the value stored in the permissible value memory 2C2 is not 0 (Yes), conclusion is made that initialization has not been carried out, and 0 is stored in the permissible value memory 2C2 in Step S12. Further, in Step S13, 0 is also stored in the measured value memory 2C3.

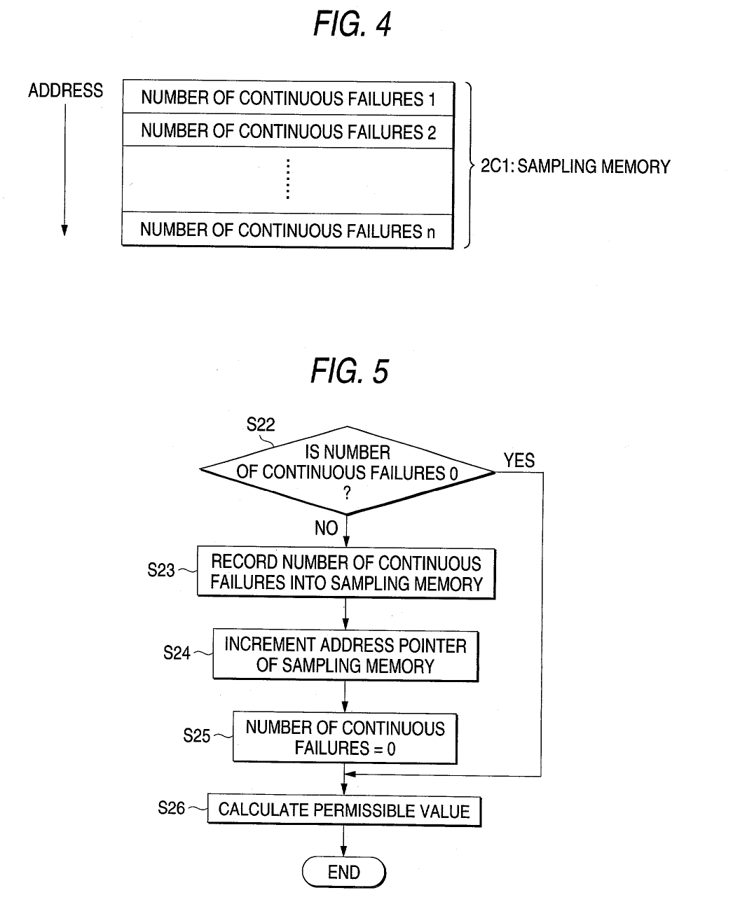

During the sampling, the sampling memory 2C1 records the number of continuous failures for every block in which a failure or failures appeared, as shown in the configuration of the sampling memory 2C1 in FIG. 4. To this end, first, in Step S14, the address pointer of the sampling memory 2Cl is set to 0.

Then, in Step S15, the IC test portion 3A tests an IC. Next, in Step S16, an IC test result is detected. If the detected IC test result is a failure (Yes), in Step S17, the number of continuous failures stored in the measured value memory 2C3 is incremented, and the incremented number of continuous failures is stored in the measured value memory 2C3 again.

If the IC test result is not a failure (No) in Step 16, in Step 18, detection is made as to whether the number of continuous failures stored in the measured value memory 2C3 is 0 or not. If the number of continuous failures is 0 (Yes), it indicates that the result of the last IC test carried out was “good” and continuous failures had not appeared. If the number of continuous failures is not 0 (No), it indicates that the result of the last IC test carried out was “bad” and continuous failures had appeared. Then, in Step S19, the number of continuous failures is stored in the current address of the sampling memory 2C1. Next, in Step S20, the address pointer of the sampling memory 2C1 is incremented, and in Step S21, the number of continuous failures stored in the measured value memory 2C3 is cleared to “0”.

Thus, while the state of the switch memory 2A is “ON”, the sampling control portion 2D stores the sampling result (number of continuous failures) into the sampling memory 2C1.

FIG. 5 is a flow chart showing the process in which a permissible value is calculated in the permissible value calculation portion 2E. The process in which a permissible value is calculated in the permissible value calculation portion 2E will be described with reference to the flow chart of FIG. 5. In Step S22, detection is made as to whether the number of continuous failures stored in the measured value memory 2C3 is 0 or not. If the number of continuous failures is 0 (Yes), it indicates that the result of the IC test carried out at the end of sampling was “good” and the sampling was not terminated in the state of continuous failures. Then, the operation goes to Step S26 which will be described later.

If the number of continuous failures is not 0 (No) in Step S22, it indicates that the result of the IC test carried out at the end of sampling was “bad” and the sampling was terminated in the state of continuous failures. Then, in Step S23, the number of continuous failures is stored in the current address of the sampling memory 2C1. Next, in Step S24, the address pointer of the sampling memory 2C1 is incremented, and in Step S25, the number of continuous failures stored in the measured value memory 2C3 is cleared to “0”.

In Step S26, all the data of the numbers of continuous failures (n pieces of data of the numbers of continuous failures in the state shown in FIG. 4) stored in the sampling memory 2C1 are read into the permissible value calculation portion 2E. The permissible value calculation portion 2E calculates a mean value μ and a standard deviation σ of all the data of the numbers of continuous failures (n pieces of data of the numbers of continuous failures in the state shown in FIG. 4), and makes the permissible value memory 2C2 store a value of μ+3σ as a permissible value.

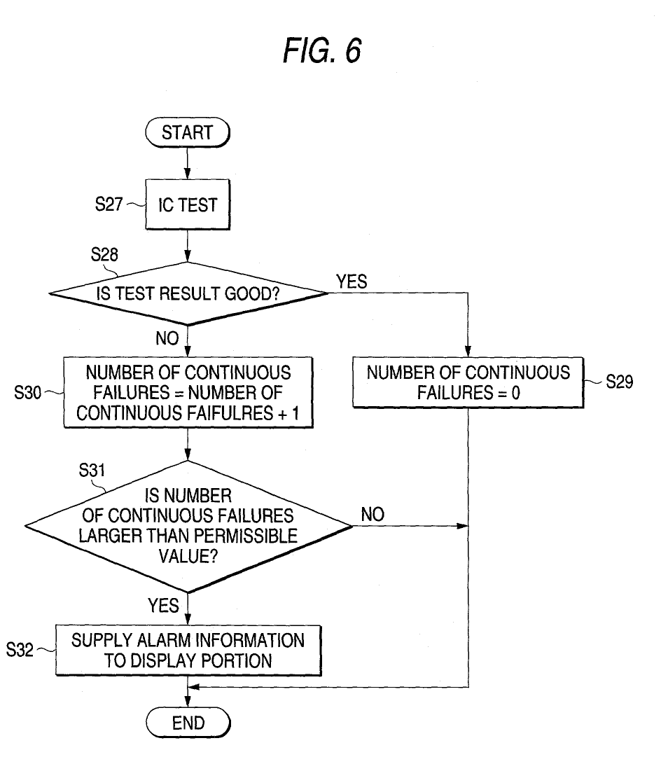

FIG. 6 is a flow chart showing the process of an IC test in the alarm control portion 2F. The process of an IC test in the alarm control portion 2F will be described with reference to the flow chart of FIG. 6. In Step S27, the IC test portion 3A tests an IC. In Step 28, an IC test result is detected. If the IC test result is “good” (Yes), the number of continuous failures stored in the measured value memory 2C3 is set to 0 in Step S29. If the IC test result is “bad” (No), the number of continuous failures stored in the measured value memory 2C3 is incremented in Step S30. Next, in Step S31, the number of continuous failures stored in the measured value memory 2C3 is compared with the permissible value stored in the permissible value memory 2C2. If the number of continuous failures stored in the measured value memory 2C3 does not exceed the permissible value stored in the permissible value memory 2C2 (No), the processing in the alarm control portion 2F is terminated. If the number of continuous failures stored in the measured value memory 2C3 exceeds the permissible value stored in the permissible value memory 2C2 (Yes), in Step S32, the alarm control portion 2F outputs an alarm display signal to the alarm display portion 4A, and the alarm display portion 4A displays an alarm.

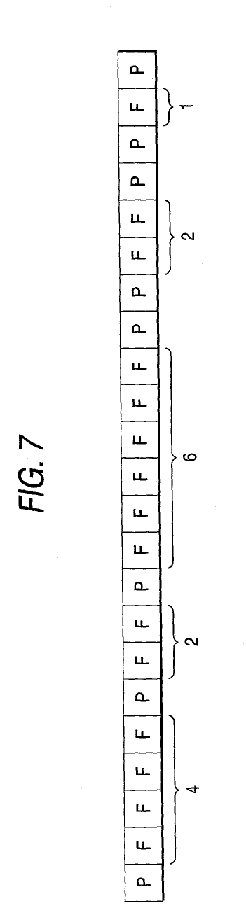

FIG. 7 is a diagram showing an example of the result of sampling. The operation of this embodiment will be described along specific examples with reference to FIG. 7. “P” in FIG. 7 designates that the result of the IC test is “good” (Pass), and “F” designates that the result is “bad” (Fail). The numbers of continuous failures stored in the sampling memory 2C1 are 4, 2, 6, 2 and 1.

When the switch memory 2A is turned “OFF” after the sampling is terminated, no permissible value is initially stored in the permissible value memory 2C2. Therefore, the permissible value calculation portion 2E calculates a permissible value. The permissible value calculation portion 2E calculates a mean value μ and a standard deviation σ of the data of the numbers of continuous failures stored in the sampling memory 2C1, and sets a value of μ+3σ as a permissible value. Here, when the process is in a stable state, it is generally known that measured values of characteristics of ICs or the like manufactured in the stable process have a normal distribution. When a normal distribution curve is divided by the standard deviation σ, the probability that a measured value will be within ±3σ is 99.7%.

Since the data of the numbers of continuous failures stored in the sampling memory 2C1 are 4, 2, 6, 2 and 1, the mean value μ becomes 3, and the standard deviation σ becomes √ ((4−3)2+(2−3)2+(6−3)2+(2−3)2+(1−3)2)=4. The permissible value calculation portion 2E calculates μ+3σ. Thus, a permissible value μ+3σ=15 is calculated. The calculated result is stored in the permissible value memory 2C2.

While the IC is being tested, the alarm control portion 2F compares the permissible value stored in the permissible value memory 2C2 with the number of continuous failures measured in the IC test. If the measured value of the number of continuous failures is not larger than 15 which is the permissible value, the IC test is kept on being performed without outputting an alarm display signal. If the measured value of the number of continuous failures becomes larger than 15 which is the permissible value, the alarm control portion 2F outputs an alarm display signal to the alarm display portion 4A, and the alarm display portion 4A displays an alarm.

According to the present invention, a permissible value can be set in accordance with the kind of an IC to be measured. Thus, for example, there is no fear that a test is kept on being performed in an abnormal state in which a permissible value has been set to be too large, so that a retest or the like must be carried out retroactively to the point of time when the test had been carried out in a normal state. Thus, there is no fear that enormous time is wasted, and it is possible to suppress loss in time in the case where an alarm is generated.

What is claimed is:

1. An alarm display unit of an IC tester for displaying an alarm when an abnormality occurs in a measured IC, the alarm display unit comprising:
a sampling control portion for collecting data in advance for use in deciding a permissible value for issuing an alarm display;
a permissible value calculation portion for calculating the permissible value on the basis of the data collected by the sampling control portion; and
an alarm control portion for judging whether the alarm is to be displayed or not, on the basis of the permissible value calculated by the permissible value calculation portion and a measured value obtained from the measured IC.

2. The alarm display unit according to claim 1, further comprising:
a sampling memory for storing the data collected by the sampling control portion;
a permissible value memory for storing the permissible value calculated by the permissible value calculation portion; and
a measured value memory for storing the measured value obtained from the measured IC, the measured value being used for comparison performed by the alarm control portion.

3. The alarm display unit according to claim 1, wherein:
the sampling control portion collects in advance data on the number of continuous failures by the measured IC;
the permissible value calculation portion calculates a mean value μ and a standard deviation a of the data on the number of continuous failures, and sets a value of μ+3σ as the permissible value; and
the alarm control portion compares the value of μ+3σ with the measured value of the number of continuous failures, and judges whether the alarm is to be displayed or not, on the basis of the comparison.

4. The alarm display unit according to claim 3, further comprising:
a sampling memory for storing the data on the number of continuous failures;
a permissible value memory for storing the value of μ+3σ; and
a measured value memory for storing the measured value of the number of continuous failures, the measured value of the number of continuous failures being used for comparison.
